(19) United States
(12) Patent Application Publication
(10) Pub. No.: US 2007/0168614 A1
(43) Pub. Date: Jul. 19, 2007

(54) Secure-Digital (SD) Flash Card with Auto-Adaptive Protocol and Capacity

(75) Inventors: Jianjun Luo, Sunnyvale, CA (US); Chris Tsu, Saratoga, CA (US); Charles C. Lee, Cupertino, CA (US); Ming-Shiang Shen, Taipei Hsien (TW)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 11/625,310

(22) Filed: Jan. 20, 2007

Related U.S. Application Data
(63) Continuation-in-part of application No. 09/478,720, filed on Jan. 6, 2000.
(63) Continuation-in-part of application No. 11/466,759, filed on Aug. 23, 2006.
Application No. 11/466,759 is a continuation-in-part of application No. 10/789,333, filed on Feb. 26, 2004, now abandoned.

(30) Foreign Application Priority Data
Jan. 20, 2006 (CN) 200620100541.2
Jan. 20, 2006 (CN) 200620100542.7

(51) Int. Cl. G06F 12/00

(52) U.S. Cl. 711/115

(57) ABSTRACT

An adaptable-capacity Secure Digital (SD) card operates as a standard-capacity SD card for a standard-capacity SD 2.0 or 1.x host, and operates as a high-capacity SD card when connected to a high-capacity SD 2.0 host. A 32-bit argument received in a SD bus transaction from the host may be a 32-bit address, which can access 4 G bytes of flash memory in standard-capacity mode. For high-capacity mode, the addressable unit is a 512-byte sector, greatly increasing the addressable memory size. A SD protocol interface on a controller chip performs handshaking with the host to determine the SD version and memory capacity of the host. Host addresses are sent as byte or sector addresses to a flash memory manager on the controller chip, depending on the capacity mode agreed on during the handshaking. Memory areas on the adaptable-capacity SD card for high and standard modes can be separate or overlapping.

### RELATED APPLICATION

This application claims the benefit under 35 USC §119(a) of China patent application No. 200620100541.2 filed 1/20/2006, and China patent application No. 200620100542.7 filed 1/20/2006.

This application is a continuation-in-part (CIP) of the co-pending application U.S. Ser. No. 09/478,720, filed 1/6/2000. This application is also a CIP of U.S. Ser. No. 11/466,759, filed Aug. 23, 2006, which is a CIP of U.S. patent application. Ser. No. 10/789,333, filed on Feb. 26, 2004, now abandoned. This application is also related to application Ser. No. 09/366,976, filed on Aug. 4, 1999, now U.S. Pat. No. 6,547,130, all of which are incorporated herein as though set forth in full.

### FIELD OF THE INVENTION

This invention relates to flash-memory cards, and more particularly to adaptable memory cards that interoperate with dual capacities and multiple versions of a standard.

### BACKGROUND OF THE INVENTION

Flash memory cards have gained acceptance for its non-volatile flash-memory storage, which is ideal for portable devices that may lose power, since the data is not lost when stored in the flash memory. Flash memories are constructed from electrically-erasable programmable read-only memory (EEPROM) cells. Since flash memory is solid-state, moving parts are not present. Flash does not fail under moderate shock or vibration that would cause a failure in a rotating disk.

Rather than use a randomly-addressable scheme such as is common with dynamic-random-access memory (DRAM), many flash memories use a block-based addressing where a command and an address are sent over the data bus and then a block of data is read or written. Since the data bus is also used to send commands and addresses, fewer pins are needed on the flash-memory chip, reducing cost. Thus flash memory is often used as a mass-storage device rather than a randomly-addressable device.

A popular bus standard is Multi-Media Card (MMC). An extension of MMC is known as Secure Digital (SD). MMC and SD flash devices are common today. These and other standards are sometimes updated. For example, SD includes an older version 1.0 and 1.1 and a newer 2.0 version. The older 1.x versions specify a 32-bit address and byte addressing, so memory capacities are limited to less than 232 or 4 Gbytes, such as an effective maximum of 2 GB. The newer 2.0 version allows for byte addressing, with its 2 GB limit, but also allows for sector addressing. Each addressable unit can be a 512-byte sector, rather than a single byte. With sector addressing, the capacity limit is increased by a factor of 512, to 2 Tbytes, which is 4 G addressable sectors.

A frequent goal of industry standards is backward compatibility. Ideally, memory cards for one version of a standard are compatible with other versions of the same standard. Such interoperability reduces consumer confusion and complaints. Unfortunately, such interoperability among versions of a same standard is not always obtained.

FIG. 1 highlights incompatibilities in SD cards of different versions of the SD standard. SD 2.0 host 26 is a host such as a card reader on a personal computer or on a personal digital assistant (PDA), cell phone, or other device that supports the newer version 2.0 of the SD standard. High-capacity SD card 22 is readable when inserted into SD 2.0 host 26. Each address generated by SD 2.0 host 26 refers to a 512-byte sector in high-capacity SD card 22, which allows high-capacity SD card 22 to have a capacity above 2 GB.

SD 2.0 host 26 can also read standard-capacity SD card 24. When standard-capacity SD card 24 is inserted into SD 2.0 host 26, each address generated by SD 2.0 host 26 refers to a byte, so the maximum memory capacity of standard-capacity SD card 24 is 4 GB.

SD 2.0 host 26 can read standard-capacity SD card 24 that was designed for the SD 1.x standard by disabling features in SD 2.0 host 26 that are available in SD 2.0 and not in SD 1.x. SD 2.0 host 26 may also read standard-capacity SD card 24 that was designed for the SD 2.0 standard, but does not support high-capacity features of SD 2.0 known as high-capacity SD (HCSD). Thus SD 2.0 host 26 is backward compatible with standard-capacity SD card 24, whether standard-capacity SD card 24 uses the 2.0 or 1.x version of the SD standard.

SD 1.x host 28 is a legacy host that was designed for version 1.0 or 1.1 of the SD standard. SD 1.x host 28 does not support extensions in the SD 2.0 standard. SD 1.x host 28 only generates byte addresses, and is not capable of generating sector addresses, so SD 1.x host 28 is limited to reading 2 GB from a SD memory card.

SD 1.x host 28 can read up to 2 GB from standard-capacity SD card 24 when inserted. When standard-capacity SD card 24 is designed for SD version 1.0 or 1.1, SD 1.x host 28 reads standard-capacity SD card 24 without problems. When standard-capacity SD card 24 is designed for SD version 2.0, SD 1.x host 28 is still able to read data stored in an “A-type” standard-capacity SD card 24 but not in a high-density SD card.

When high-capacity SD card 22 is inserted into SD 1.x host 28, SD 1.x host 28 is unable to read the data stored in high-capacity SD card 22 since SD 1.x host 28 generates byte addresses, while standard-capacity SD card 24 interprets the addresses as each reading a whole 512-byte sector. Thus high-capacity SD card 22 is incompatible with SD 1.x host 28.

Consumers who purchase a newer high-capacity SD card 22 may be quite disappointed when inserting high-capacity SD card 22 into an older PC or device that contains SD 1.x host 28, since the newly-purchased high-capacity SD card 22 is unreadable. Consumers may assume that high-capacity SD card 22 is broken, lowering the reputation of the manufacturer of high-capacity SD card 22.

As described above, high-capacity SD card 22 has only a memory area for high-capacity hosts. This is known as a Type A card. Another type of high-capacity SD card 22 is known as a Type B card. Type B cards have both a high-capacity memory area and a standard-capacity memory area on the same card. A mechanical switch is included in the Type-B card.

When the mechanical switch on the Type-B card is slid into a first position, only the high-capacity memory area is accessible, so SD 2.0 host 26 can access the card, but SD 1.x host 28 cannot access the card. When the mechanical switch on the Type-B card is slid into a second position, only the standard-capacity memory area is accessible, so SD 2.0 host 26 cannot access the card, but SD 1.x host 28 can access the card. Only one of the memory areas can be accessed at any time, depending on the position of the mechanical switch.

The lack of automated backward compatibility of high-capacity SD card 22 with older SD 1.x host 28 is undesirable. Using a mechanical switch is also undesirable. Backward compatibility, even when the memory capacity of high-capacity SD card 22 is limited to the older SD 1.x host 28, is desired. An adaptable high-capacity SD card is desired that can operate with both 1.x and 2.0 hosts, and can adapt its memory capacity for high-capacity and standard-capacity SD hosts.

### BRIEF DESCRIPTION OF THE DRAWINGS

FIG. 1 highlights incompatibilities in SD cards of different versions of the SD standard.

FIG. 2 highlights backward compatibility of an adaptable SD card.

FIG. 3 is a diagram of an adaptable SD card with a controller chip that can operate with different hosts.

FIG. 4A shows separate memory spaces for standard-capacity and high-capacity hosts on the adaptable-capacity SD card.

FIG. 4B shows overlapping memory spaces for standard-capacity and high-capacity hosts on the adaptable-capacity SD card.

FIG. 5 shows a transaction on the SD bus.

FIG. 6 shows the controller chip in more detail.

FIGS. 7A-B shows a flowchart of initialization of an adaptable-capacity SD card.

FIGS. 8A-B shows a flowchart of initialization of an adaptable-version SD card.

FIG. 9 is a block diagram of a SD flash microcontroller.

FIG. 10 shows external pin connections to a SD/MMC single-chip flash device.

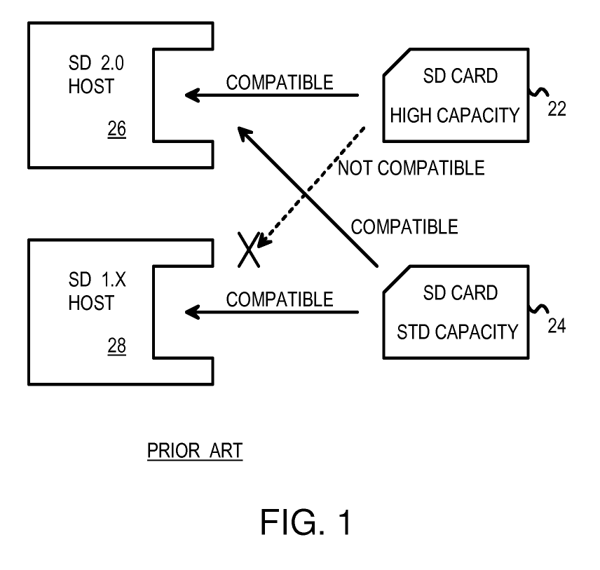

### DETAILED DESCRIPTION

The present invention relates to an improvement in dual-capacity adaptable memory cards. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

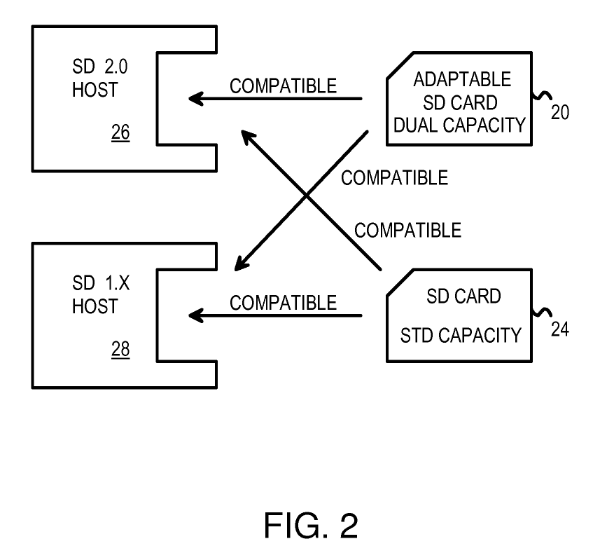

FIG. 2 highlights backward compatibility of an adaptable SD card. Adaptable-capacity SD card 20 operates as a high-capacity SD card when inserted into SD 2.0 host 26, allowing SD 2.0 host 26 to read more than 4 GB by using sector addressing. When adaptable-capacity SD card 20 is inserted into SD 1.x host 28, adaptable-capacity SD card 20 operates as a standard-capacity SD card, limiting SD 1.x host 28 to reading a memory size to 2 GB or less.

Adaptable-capacity SD card 20 detects the SD version and capacity supported by the host during an initialization period when first inserted into the host. Adaptable-capacity SD card 20 interprets each host address as a byte address when a standard-capacity host is detected by adaptable-capacity SD card 20, but interprets each address as a sector address when a high-capacity host is detected.

Like standard-capacity SD card 24, which is readable by both SD 1.x host 28 and SD 2.0 host 26, adaptable-capacity SD card 20 allows its flash memory to be read by both SD 1.x host 28 and SD 2.0 host 26. The size of the accessible flash memory is limited for SD 1.x host 28, while the accessible flash-memory size is greater for SD 2.0 host 26.

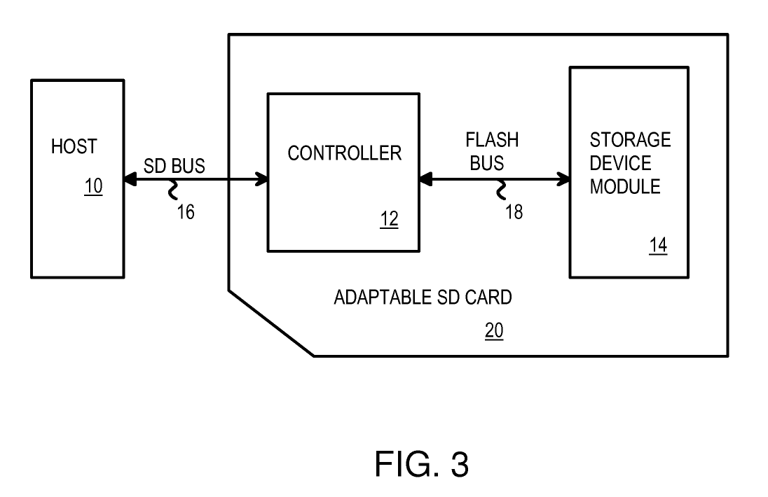

FIG. 3 is a diagram of an adaptable SD card with a controller chip that can operate with different hosts. Adaptable-capacity SD card 20 stores data in storage device module 14, which can be a single flash-memory chip, multiple chips, or a module of several chips.

Controller chip 12 contains a flash controller that generates flash commands on flash bus 18 to storage device module 14, and also contains an SD protocol controller that receives commands from host 10 over SD bus 16. Controller chip 12 may contain a microcontroller or may have dedicated logic to perform various protocol and flash-memory functions.

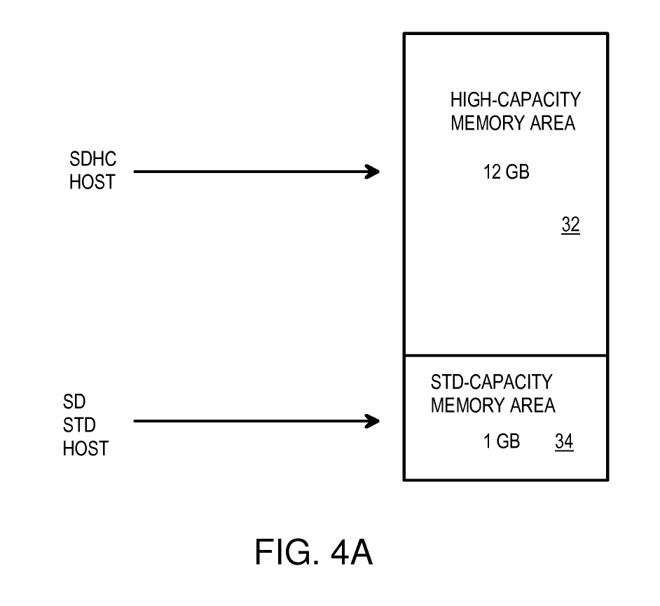

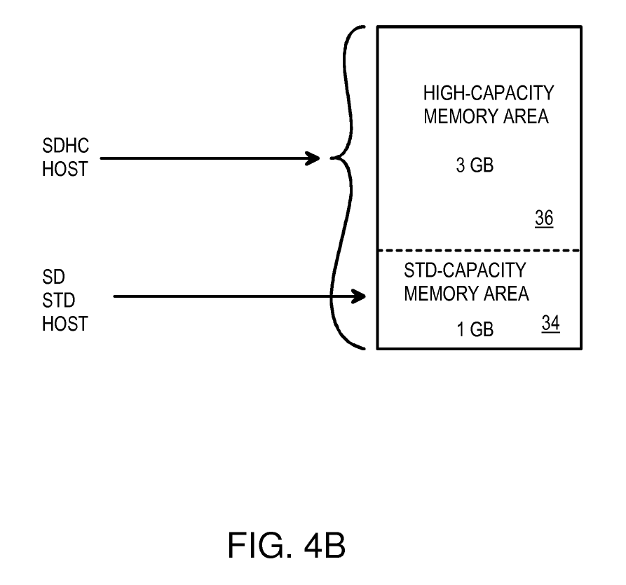

FIG. 4A shows separate memory spaces for standard-capacity and high-capacity hosts on the adaptable-capacity SD card. A SD 1.x host or a SD 2.0 host that only supports standard capacity (byte-addressing) has its reads, writes, and erases directed to standard-capacity memory area 34. The size of standard-capacity memory area 34 is limited to 2 GB or less, since a 32-bit address can access only 2 G bytes. One of the 32 address bits is unusable for addressing, so the limit is reduced to 2 GB.

A SD 2.0 host that supports sector-addressing can access high-capacity memory area 32. High-capacity memory area 32 can be much larger than 2 GB, since the smallest addressable unit is a sector rather than a byte. Since flash memory is often read and written in blocks rather than in individual bytes, sector addressing is not as restrictive for mass storage applications that employ block addressing rather than random addressing.

A HCSD 2.0 host cannot access memory in standard-capacity memory area 34, while a SD 1.x host or a standard-capacity SD 2.0 host cannot access memory in high-capacity memory area 32 in this embodiment. There is no overlap of memory areas for standard and high-capacity hosts. This embodiment provides memory-area protection since separate memory spaces are used.

The adaptable-capacity SD card has a total memory size of the sum of the accessible areas of standard and high-capacity hosts, or the sum of high-capacity memory area 32 and standard-capacity memory area 34. For example, when high-capacity memory area 32 has 12 GB, while standard-capacity memory area 34 has 1 GB, the total memory size on adaptable-capacity SD card 20 is 13 GB. A adaptable-capacity SD card 20 with a total memory of 16 GB could allocate 12 GB for high-capacity memory area 32 and 2 GB for standard-capacity memory area 34.

FIG. 4B shows overlapping memory spaces for standard-capacity and high-capacity hosts on the adaptable-capacity SD card. A SD 1.x host or a SD 2.0 host that only supports standard capacity (byte-addressing) has its reads, writes, and erases directed to standard-capacity memory area 34. The size of standard-capacity memory area 34 is limited to 2 GB or less, since a 32-bit address can access only 2 G bytes.

A SD 2.0 host that supports sector-addressing can access both high-capacity memory area 36 and standard-capacity memory area 34. High-capacity memory area 36 can be much larger than 2 GB, since the smallest addressable unit is a sector rather than a byte.

A SD 1.x host or a standard-capacity SD 2.0 host cannot access memory in high-capacity memory area 32, but a HCSD 2.0 host can access standard-capacity memory area 34 as well as high-capacity memory area 36 in this embodiment. Memory areas overlap for standard and high-capacity hosts. This embodiment allows the high-capacity host to read data in standard-capacity memory area 34 that was written by a standard-capacity host. Thus data can be carried from a standard-capacity host to a high-capacity host, or vice-versa when the data is stored in standard-capacity memory area 34.

Rather than have separate memory areas as shown, standard-capacity memory area 34 could be interleaved or striped within high-capacity memory area 36. For example, the first byte of each sector could belong to standard-capacity memory area 34, while the other 511 bytes belong to high-capacity memory area 36.

The adaptable-capacity SD card has a total memory size of the accessible area of the high-capacity hosts. This is the sum of high-capacity memory area 36 and standard-capacity memory area 34. For example, when high-capacity memory area 36 has 3 GB, while standard-capacity memory area 34 has 1 GB, the total memory size on adaptable-capacity SD card 20 is 4 GB. An adaptable-capacity SD card 20 with a total memory of 16 GB could allocate 14 GB for high-capacity memory area 36 and 2 GB for standard-capacity memory area 34.

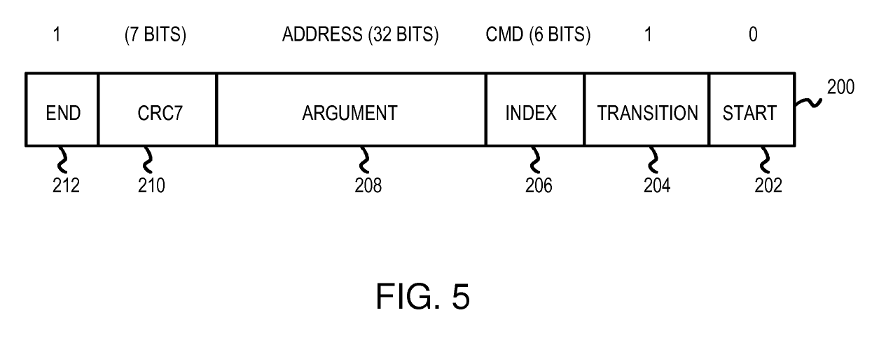

FIG. 5 shows a transaction on the SD bus. Transaction frame 200 is a series of bits sent over the SD bus from the host to the adaptable-capacity SD card. The bits may be interleaved or otherwise partitioned among the parallel data bits in the SD bus and then re-assembled into a transaction frame as shown.

Start bit 202 is a 0 bit that identifies the start of transaction frame 200. Transition bit 204 indicates the direction of the transmission, either from host to peripheral (card), or from peripheral to the host. Index 206 contains 6 bits that encode the host command. Argument 208 is a 32-bit address, which is a byte address for standard-capacity hosts, or a sector address for high-capacity hosts. CRC 210 is a 7-bit cyclical-redundancy-check (CRC) checksum of the other fields in transaction frame 200 and is used for detecting transmission errors. End bit 212 marks the end of transaction frame 200.

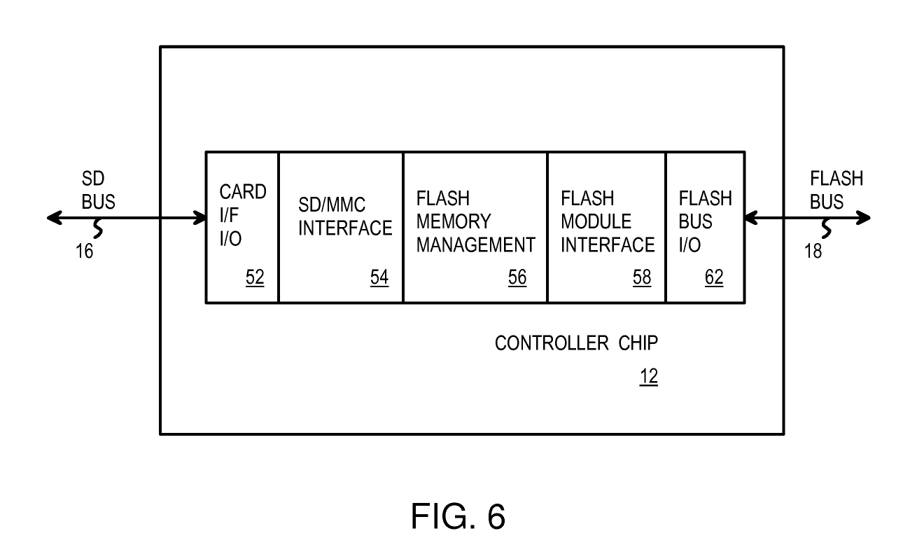

FIG. 6 shows the controller chip in more detail. SD protocol interface 54 receives and interprets commands, addresses, and data in bus transactions from the host that are received by card interface I/O 52 from SD bus 16.

Flash memory manager 56 performs memory management functions such as address translation to perform wear-leveling and bad-block avoidance of physical blocks in storage device module 14 (FIG. 3). Flash module interface 58 generates the low-level commands to erase, write, and read blocks of data in storage device module 14 that are sent over flash bus 18 by flash bus I/O 62.

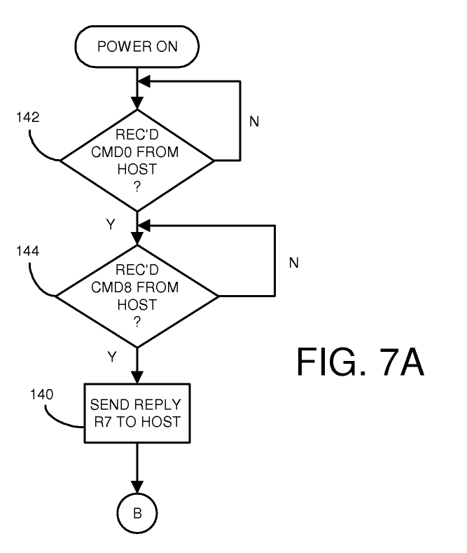

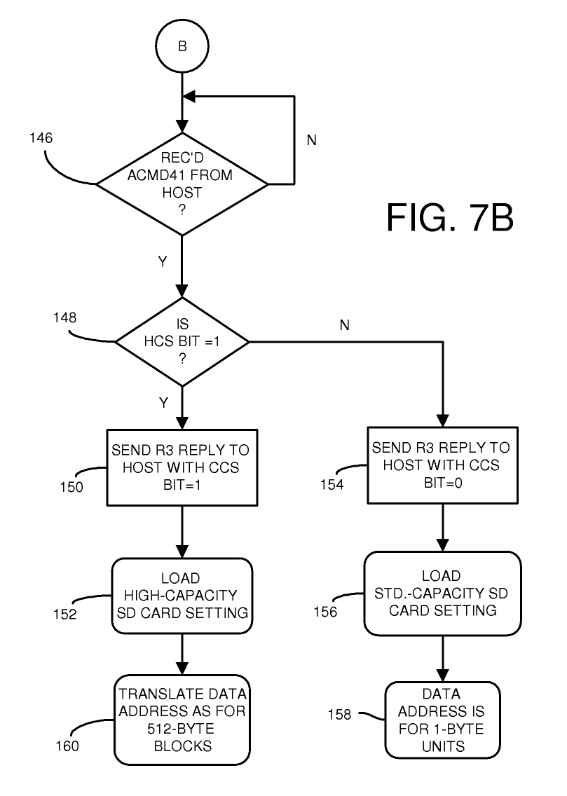

FIGS. 7A-B shows a flowchart of initialization of an adaptable-capacity SD card. When the adaptable-capacity SD card is inserted into the host, or when the host is powered up with a card already inserted, this routine is activated on the controller chip on the adaptable-capacity SD card. The card waits for a CMD0 command from the host, step 142. CMD0 is a command encoded by index 206 (FIG. 5), which contains 6 bits that encode the host command. If an invalid command is received, adaptable-capacity SD card 20 waits for a valid command to be sent.

After CMD0 is received from the host, the card waits for a valid CMD8 command from the host, step 144. Once the valid CMD8 is received and decoded, the adaptable-capacity SD card generates a R7 reply, which is sent in a SD transaction to the host over the SD bus, step 140.

In FIG. 7B, the card waits for a valid ACMD41 from the host, step 146. Once ACMD41 is received, the card controller reads the host capacity support HCS bit that was contained in a 32-bit argument field of the ACMD41, step 148. When the HCS bit is a 1, the card controller generates a R3 reply to the host with the card capacity support CCS bit set to 1, step 150.

The card controller has determined that the host supports high-capacity or sector-addressing. The exchange of commands and replies confirms that the host intends to use sector addressing. The card controller therefore loads high-capacity settings, step 152. The SD protocol interface, flash memory manager, and flash module interface operate by assuming that host addresses are for 512-byte sectors, rather than for bytes. In particular, the flash memory manager or the SD protocol interface may be configured to shift or multiply each host address by 512 to get the address in bytes of flash data, step 160.

When the HCS bit is a 0, step 148, the card controller generates a R3 reply to the host with the CCS confirm bit set to 0, step 154. The card controller has determined that the host does not support high-capacity or sector-addressing. Only byte addressing is supported for a standard-capacity host. The exchange of commands and replies confirms that the host intends to use byte addressing.

The card controller therefore loads standard-capacity settings, step 156. The SD protocol interface, flash memory manager, and flash module interface operate by assuming that host addresses are for bytes, rather than for larger sectors. In particular, the flash memory manager or the SD protocol interface may be configured to pass through without shifting or multiplying each host address by 512, so that the host address is used as the flash address in bytes of flash data, step 158.

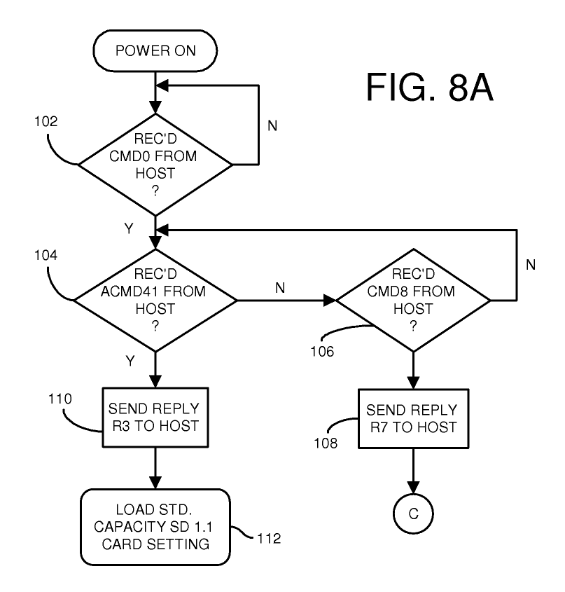

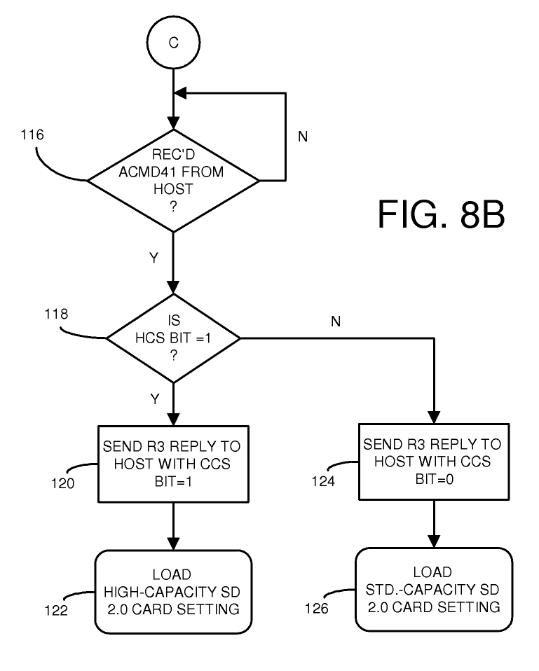

FIGS. 8A-B shows a flowchart of initialization of an adaptable-version SD card. When the adaptable-version SD card is inserted into the host, or when the host is powered up with a card already inserted, this routine is activated on the controller chip on the adaptable-version SD card. The card waits for a CMD0 command from the host, step 102. CMD0 is a command encoded by index 206 (FIG. 5), which contains 6 bits that encode the host command. If an invalid command is received, adaptable-version SD card 20 waits for a valid command to be sent.

After CMD0 is received from the host, the card loops through steps 104, 106 until either a CMD8 or an ACMD41 is received.

Sometimes a valid ACMD41 command is received from the host, step 104. Once the valid ACMD41 is received and decoded, the adaptable-version SD card generates a R3 reply, which is sent in a SD transaction to the host over the SD bus, step 110. The host is a SD 1.x host. The card loads its SD 1.x settings, step 112. Addresses from the host are interpreted as byte addresses, and SD 2.0 enhanced features are not supported.

If no ACMD41 is received, step 104, but a CMD8 is received, step 106, the adaptable-version SD card generates a R7 reply, which is sent in a SD transaction to the host over the SD bus, step 108.

In FIG. 8A, at step 108, a CMD8 has been received (step 106, but not an ACMD41 (step 104). In FIG. 8B, the card waits for a valid ACMD41 from the host, step 116. Once ACMD41 is received, the card controller reads the HCS capacity bit that was contained in the argument field of the ACMD41, step 118. When the HCS bit is a 1, the card controller generates a R3 reply to the host with the CCS confirm bit set to 1, step 120.

The card controller has determined that the host supports SD 2.0, and also supports high-version or sector-addressing. The exchange of commands and replies confirms that the host intends to use sector addressing. The card controller therefore loads high-version settings, step 122. The SD protocol interface, flash memory manager, and flash module interface operate by assuming that host addresses are for 512-byte sectors, rather than for bytes. In particular, the flash memory manager or the SD protocol interface may be configured to shift or multiply each host address by 512 to get the address in bytes of flash data.

When the HCS bit is a 0, step 118, the card controller generates a R3 reply to the host with the CCS confirm bit set to 0, step 124. The card controller has determined that the host is a SD 2.0 host, but the SD 2.0 host does not support high-capacity or sector-addressing. Only byte addressing is supported for a standard-capacity host. The exchange of commands and replies confirms that the host intends to use byte addressing with SD 2.0.

The card controller therefore loads standard-capacity SD 2.0 settings, step 126. The SD protocol interface, flash memory manager, and flash module interface operate by assuming that host addresses are for bytes, rather than for larger sectors. In particular, the flash memory manager or the SD protocol interface may be configured to pass through without shifting or multiplying each host address by 512, so that the host address is used as the flash address in bytes of flash data.

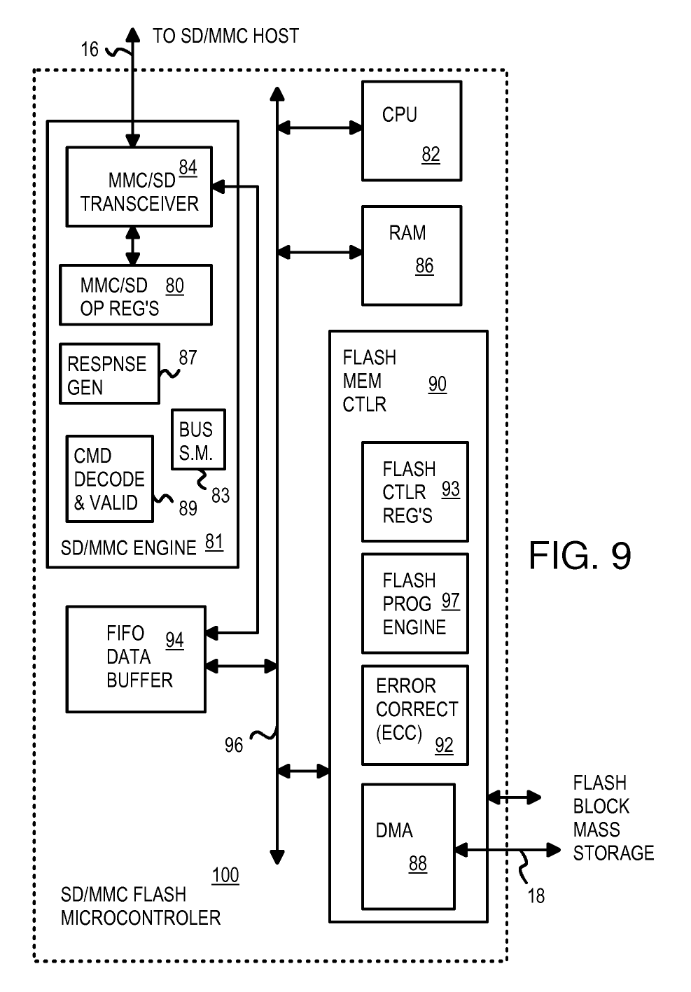

FIG. 9 is a block diagram of a SD flash microcontroller. SD flash microcontroller 100 can replace controller chip 12 of FIG. 3. Internal bus 96 connects CPU 82 with RAM 86, FIFO data buffer 94, direct-memory access (DMA) engine 88, and flash-memory controller 90. CPU 82 executes instructions from RAM 86, while DMA engine 88 can be programmed to transfer data between FIFO data buffer 94 and flash-memory controller 90. CPU 82 can operate on or modify the data by reading the data over bus 96. RAM 86 can store instructions for execution by the CPU and data operated on by the CPU.

SD transceiver 84 connects to the clock CLK and parallel data lines D0:3 of SD bus 16 and contains both a clocked receiver and a transmitter. An interrupt to CPU 82 can be generated when a new command is detected on SD bus 16. CPU 82 can then execute a routine to handle the interrupt and process the new command.

SD operating registers 80 include the protocol registers required by the SD specification. Registers may include a data-port, write-protect, flash select, flash status, interrupt, and identifier registers. Other extension registers may also be present.

Command decode and validator 89 detects, decodes, and validates commands received over SD bus 16. Valid commands may alter bus-cycle sequencing by bus state machine 83, and may cause response generator 87 to generate a response, such as an acknowledgement or other reply.

During card initialization, command decode and validator 89 receives host commands such as ACMD41 and CMD8 and responds with responses such as R3. In particular, command decode and validator 89 can determine the type of host attached, either high-capacity with sector addressing, or standard-capacity with byte addressing. Once the host type is determined by command decode and validator 89, future commands can be interpreted as referring to a byte or a sector. Different routines can be executed by CPU 82 or different transfer lengths can be performed by DMA engine 88 in response to the byte or sector capacity detected by command decode and validator 89.

The transmit and receive data from SD engine 81 is stored in FIFO data buffer 94, perhaps before or after passing through a data-port register in SD operating registers 80. Commands and addresses from the SD transactions can also be stored in FIFO data buffer 94, to be read by CPU 82 to determine what operation to perform.

Flash-memory controller 90 includes flash data buffer 98, which may contain the commands, addresses, and data sent over internal flash bus 18 to one or more flash mass storage chips. Data can be arranged in flash data buffer 98 to match the bus width of internal flash bus 18, such as in 32 or 94-bit words. DMA engine 88 can be programmed by CPU 82 to transfer a block of data between flash data buffer 98 and FIFO data buffer 94.

Flash control registers 93 may be used in conjunction with flash data buffer 98, or may be a part of flash memory buffer 98. Flash-specific registers in flash control registers 93 may include a data port register, interrupt, flash command and selection registers, flash-address and block-length registers, and cycle registers.

Error-corrector 92 can read parity or error-correction code (ECC) from flash mass storage chips and perform data corrections. The parity or ECC bits for data in flash data buffer 98 that is being written to flash mass storage chips can be generated by error-corrector 92.

Flash programming engine 97 can be a state machine that is activated on power-up reset. Flash programming engine 97 programs DMA engine 88 within the address of the boot loader code in the first page of the flash mass storage chip, and the first address in RAM 86. Then flash programming engine 97 commands DMA engine 88 to transfer the boot loader from the flash mass storage chip to RAM 86. CPU 82 is then brought out of reset, executing the boot loader program starting from the first address in RAM 86. The boot loader program can contain instructions to move a larger control program from the flash mass storage chip to RAM 86. Thus SD flash microcontroller 100 is booted without an internal ROM on internal bus 96.

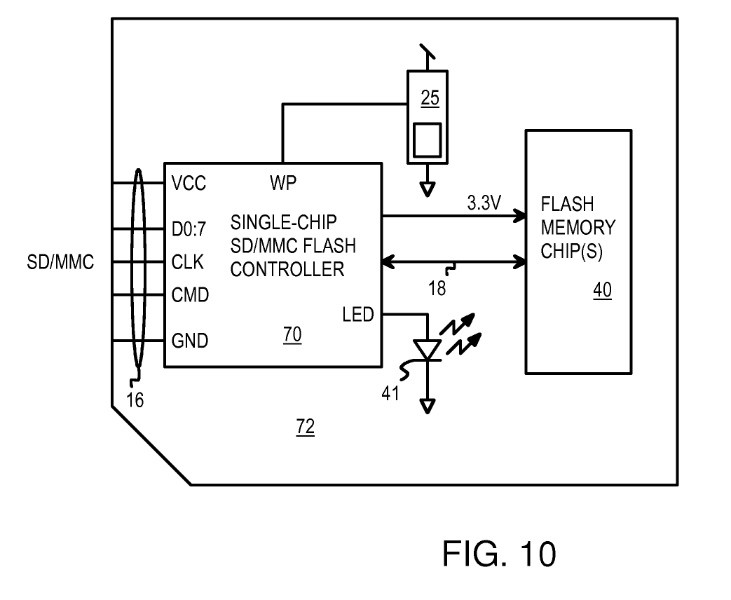

FIG. 10 shows external pin connections to a SD/MMC single-chip flash device. SD single-chip flash device 70 on SD card 72 connects to the host through SD bus 16, which has power (Vcc), ground, a clock that is input to SD single-chip flash device 70, and a parallel data bus. The data bus may be 4 or 8 bits for various versions of the MMC and SD standards. A command pin CMD may also be present for the SD standard or may be multiplexed with a SD data pin. The data pins are full-swing non-differential and carry parallel data synchronized to the clock.

A write-protect (WP) pin connects externally to switch 25. Switch 25 can be switched by the user to indicate write-protect or write-enable modes of the flash memory inside SD single-chip flash device 70.

A status output pin for a light-emitting diode (LED) can be included on some embodiments. The status-LED pin can drive LED 41 to indicate a status of SD single-chip flash device 70. For example, LED 41 can be made to blink when flash memory 40 is being written so that the user does not unplug the device before writing is completed.

Relatively few pins are needed for SD single-chip flash device 70. Since SD bus 18 is 10 pins or less, depending on the SD version, excluding power and ground, as few as 10 signal pins are needed when no LED signaling is required. All commands, addresses, status, and data are carried as parallel clocked-data over the data lines in SD bus 16. Additional power and ground pins, or pins for other functions could be added, but packages with 10 signal pins are relatively inexpensive and require little board space. The total pin count on the package may be 20 or fewer pins. Power consumption is also reduced, since fewer higher-capacitance external signals are driven by SD single-chip flash device 70.

When the adaptable-capacity SD card is inserted into a high-capacity host, larger sectors of data may be transferred, requiring many more data transfer cycles that when a standard-capacity host is used.

### Alternative Embodiments

Several other embodiments are contemplated by the inventors. For example different numbers and arrangements of SD flash blocks can connect to the controller. Rather than use SD buses, other buses may be used such as Memory Stick, PCI Express bus, Compact Flash (CF), IDE bus, Serial ATA (SATA) bus, etc. Additional pins can be added or substituted for the SD data pins. A multi-bus-protocol chip could have an additional personality pin to select which bus interface to use, or could have programmable registers. Rather than have a SD microcontroller, a Memory Stick microcontroller could be substituted, for use with a memory-stick interface, etc.

While the invention has been described using an SD controller, a MMC controller may be substituted. A combined controller that can function for both MMC and SD may also be substituted. SD may be considered an extension of MMC, or a particular type of MMC, rather than a separate type of bus.

While the invention has been described as not requiring ROM for booting, some ROM may still be present on the chip. For example, a revision number may be included in a small ROM. Hard-wired gates that are tied to power or ground may also function as a read-only memory. While such ROM may be present, ROM is not required for storing boot code or booting instructions. A few bytes or more of ROM may be thus present for other purposes.

Mode logic could sense the state of a pin only at power-on rather than sense the state of a dedicated pin. A certain combination or sequence of states of pins could be used to initiate a mode change, or an internal register such as a configuration register could set the mode.

The microcontroller and SD components such as the bus interface, DMA, flash-memory controller, transaction manager, and other controllers and functions can be implemented in a variety of ways. Functions can be programmed and executed by the CPU or other processor, or can be implemented in dedicated hardware, firmware, or in some combination. Many partitioning of the functions can be substituted.

Data and commands may be routed in a variety of ways, such as through data-port registers, FIFO or other buffers, the CPU's registers and buffers, DMA registers and buffers, and flash registers and buffers. Some buffers may be bypassed or eliminated while others are used or present. Virtual or logical buffers rather than physical ones may also be used. Data may be formatted in a wide variety of ways.

The host can transfer standard SD commands and data transactions to the SD transceiver during a transaction. Other transaction types or variations of these types can be defined for special purposes. These transactions may include a flash-controller-request, a flash-controller-reply, a boot-loader-request, a boot-loader-reply, a control-program-request, a control-program-reply, a flash-memory-request, and a flash-memory-reply. The flash-memory request/reply may further include the following request/reply pairs: flash ID, read, write, erase, copy-back, reset, page-write, cache-write and read-status.

The host may be a personal computer (PC), a portable computing device, a digital camera, a phone, a personal digital assistant (PDA), or other electronic device.

Wider or narrower data buses and flash-memory blocks could be substituted, such as 4, 5, 8, 16, 32, 64, 128, 256-bit, or some other width data channels. Alternate bus architectures with nested or segmented buses could be used internal or external to the microcontroller. Two or more internal and flash buses can be used in the SD flash microcontroller to increase throughput. More complex switch fabrics can be substituted for the internal buses.

The flash mass storage blocks can be constructed from any flash technology including NAND, NOR, AND, or multi-level-logic (MLC) memory cells. Data striping could be used with the flash mass storage blocks in a variety of ways, as can parity and error-correction code (ECC). Data re-ordering can be adjusted depending on the data arrangement used to prevent re-ordering for overlapping memory locations. An SD/MMC switch could be integrated with other components or could be a stand-alone chip. The SD/MMC switch could also be integrated with the SD single-chip flash device. While a single-chip device has been described, separate packaged chips or die may be stacked together while sharing I/O pins, or modules may be used.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. An automatic adaptable-capacity protocol card comprising:
a flash-memory chip for storing blocks of data in a non-volatile flash memory;
an insertable end for inserting into a protocol socket on a host;
a bus connection formed on the insertable end, for mating with connectors on the protocol socket on the host to connect to a host protocol bus on the host;
a controller core on the automatic adaptable-capacity protocol card;
a flash controller in the controller core for communicating with the flash-memory chip;
a protocol controller in the controller core for communicating with the host;
a handshake routine executed by the controller core, the handshake routine receiving commands from the host and generating replies to the host over the host protocol bus to determine a capacity-version of the host; and
an adaptable address translator, coupled to the protocol controller to receive a host address from the host over the host protocol bus, for generating a translated address to the flash controller;
wherein the translated address is the host address when the capacity-version of the host is a standard capacity;
wherein the translated address is the host address multiplied by a sector size when the capacity-version of the host is a high capacity that is greater than the standard capacity;
whereby host addresses are translated in response to the capacity-version of the host detected by the handshake routine.

2. The automatic adaptable-capacity protocol card of claim 1 wherein the sector size is 512 bytes;
wherein the translated address is 512 times the host address when the capacity-version of the host is the high capacity.

3. The automatic adaptable-capacity protocol card of claim 2 wherein the host address is extracted from an argument field in a bus transaction on the host protocol bus by the protocol controller.

4. The automatic adaptable-capacity protocol card of claim 2 wherein the controller core further comprises:
a flash memory manager for translating the translated address from the adaptable address translator to generate a physical addresses of blocks within the flash-memory chip; and
a flash module interface for generating erase, write, and read commands of blocks in the flash-memory chip using the physical addresses from the flash memory manager.

5. The automatic adaptable-capacity protocol card of claim 4 further comprising:
a flash bus connected to the flash-memory chip, for carrying data and physical addresses of blocks being erased, written, or read in the flash-memory chip.

6. The automatic adaptable-capacity protocol card of claim 2 wherein the host protocol bus is a secure digital (SD) protocol bus;
wherein the host is a SD version 1.0 or a SD version 1.1 host or a standard-capacity SD version 2.0 host when the capacity-version of the host is the standard capacity;
wherein the host is a high-capacity SD version 2.0 host when the capacity-version of the host is the high capacity.

7. The automatic adaptable-capacity protocol card of claim 1 wherein a first useable memory area accessible by the flash controller in the flash-memory chip is 2 G bytes or less when the capacity-version of the host is the standard capacity;
wherein a second useable memory area accessible by the flash controller in the flash-memory chip is greater than 2 G bytes when the capacity-version of the host is the high capacity.

8. The automatic adaptable-capacity protocol card of claim 7 wherein the first useable memory area and the second useable memory area comprise non-overlapping physical memory locations in the flash-memory chip.

9. The automatic adaptable-capacity protocol card of claim 7 wherein the first useable memory area and the second useable memory area comprise overlapping physical memory locations in the flash-memory chip;
wherein the flash controller is able to access physical memory locations in the first useable memory area when accessing the second useable memory area when the capacity-version of the host is the high capacity.

10. The automatic adaptable-capacity protocol card of claim 1 wherein the host protocol bus is a secure digital (SD) protocol bus, a Multi-Media Card (MMC) protocol bus, a Compact Flash (CF) protocol bus, a Memory-Stick protocol bus, a PCI Express protocol bus, an IDE protocol bus, or a Serial ATA (SATA) protocol bus.

11. An adaptive-version controller chip comprising:
a flash bus for connecting to a flash-memory chip, the flash bus carrying address, data, and commands to the flash-memory chip;
a clocked-data interface to a host bus that connects to a host having a protocol version;
a bus transceiver for detecting and processing commands sent over the host bus;
a buffer for storing data sent over the host bus;
an internal bus coupled to the buffer;
a random-access memory (RAM) for storing instructions for execution, the RAM on the internal bus;
a central processing unit (CPU), on the internal bus, the CPU accessing and executing instructions in the RAM;
a flash-memory controller, on the internal bus, for generating flash-control signals and for buffering commands, addresses, and data to the flash bus;
a direct-memory access (DMA) engine, on the internal bus, for transferring data over the internal bus; and
an initialization routine, executed by the CPU to receive commands from the host through the bus transceiver, and for sending replies to the host, the initialization routine detecting the protocol version of the host and setting a version mode that the adaptive-version controller chip operates with,
whereby the protocol version is detected by the initialization routine.

12. The adaptive-version controller chip of claim 11 wherein the host bus is a Secure Digital (SD) protocol bus operating according to the protocol version of the host.

13. The adaptive-version controller chip of claim 12 wherein the protocol version is Secure Digital (SD) version 1.x or is Secure Digital (SD) version 2.0.

14. The adaptive-version controller chip of claim 11 wherein the protocol version further comprises a capacity-version, wherein the capacity-version is a standard-capacity for Secure Digital (SD) version 1.x and for standard-capacity Secure Digital (SD) version 2.0;
wherein the capacity-version is a high-capacity for High-Capacity Secure Digital (HCSD) version 2.0;
further comprising:
standard configuration means, activated by the initialization routine, for configuring the flash-memory controller to access a flash memory of no more than 2 G bytes when the capacity-version is the standard-capacity; and
high configuration means, activated by the initialization routine, for configuring the flash-memory controller to access a flash memory of more than 2 G bytes when the capacity-version is the high-capacity.

15. The adaptive-version controller chip of claim 14 wherein the initialization routine comprises:
CMD0 detect means for detecting when the bus transceiver receives a CMD0 command from the host;
ACMD41 detect means for detecting when the bus transceiver receives an ACMD41 command from the host;
first reply means for generating a reply to the host when the CMD0 detect means or the ACMD41 detect means detects a command from the host;
host capacity support means for reading a host capacity support bit received by the bus transceiver from the host;
version generator means for generating the capacity-version from the host capacity support bit; and
card capacity support reply means for echoing the host capacity support bit back to the host in a reply as a card capacity support bit that indicates the capacity-version.

16. The adaptive-version controller chip of claim 14 further comprising:
flash memory manager means for translating host addresses received from the host by the bus transceiver into physical addresses to the flash-memory controller, wherein when the capacity-version indicates the high capacity, the flash memory manager means multiplies the host address by a sector size to generate the physical address.

17. The adaptive-version controller chip of claim 16 wherein the sector size is 512 bytes.

18. The adaptive-version controller chip of claim 16 wherein data in the flash-memory chip are accessible by the flash-memory controller sending a request sequence over the flash bus, the request sequence including a command followed by the physical address;
wherein the data in the flash-memory chip is block-addressable while the RAM is randomly-addressable by the CPU.

19. A dual-version flash drive comprising:
a flash-memory means for storing blocks of data in a non-volatile memory that retains data when power is lost;
a first area of the flash-memory means, for storing data for a standard-capacity host;
a second area of the flash-memory means, for storing data for a high-capacity host;
wherein the second area is larger than the first area;
a Secure Digital (SD) interface that connects to a host over a SD host bus;
protocol interface means for extracting host commands from host transactions received over the SD host bus from the host;
flash memory manager means for translating addresses in the host commands to physical addresses of blocks within the flash-memory means;
flash interface means for generating erase, write, and read commands of blocks in the flash-memory means using the physical addresses from the flash memory manager means;
version-detect means, activated when the dual-version flash drive is connected to the host, for detecting a version of the host;
standard configuration means for configuring the flash-memory manager means to access the first area of the flash-memory means and to disable access to the second area of the flash-memory means when the version-detect means detects that the host has a version for the standard-capacity host;
high configuration means for configuring the flash-memory manager means to access the second area of the flash-memory means and to disable access to the first area of the flash-memory means when the version-detect means detects that the host has a version for the high-capacity host,
whereby access to the first area of the flash-memory means is enabled for the standard-capacity host, and disabled for the high-capacity host, while access to the second area of the flash-memory means is enabled for the high-capacity host, and disabled for the standard-capacity host.

20. The dual-version flash drive of claim 19 wherein the flash-memory manager means further comprises:
byte-addressing means, activated by the standard configuration means, for interpreting host addresses as byte addresses when the host is a standard-capacity host;
sector-addressing means, activated by the high configuration means, for interpreting host addresses as sector addresses when the host is a high-capacity host;
wherein sector addresses are for multi-byte sectors.
